(19) United States
(12) Patent Application Publication
(10) Pub. No.: US 2013/0049908 A1
(43) Pub. Date: Feb. 28, 2013

(54) COMPONENT AND MANUFACRING PROCESS OF RARE EARTH PERMANENT MAGNET MATERIAL

(71) Applicant: Wen Jie Yuan, Tianjin (CN)

(72) Inventor: Wen Jie Yuan, Tianjin (CN)

(21) Appl. No.: 12/995,469

(22) PCT Filed: May 20, 2010
(86) PCT No.: PCT/CN10/73002

§ 371 Date: Dec. 1, 2010

(30) Foreign Application Priority Data
Apr. 28, 2010 (CN) 2010158031.1

(51) Int. Cl. H01F 7/02; H01F 41/02

(52) U.S. Cl. 335/302; 419/23

(57) ABSTRACT

The invention relates to a component of rare earth permanent magnet material, and the atomic percents of the material are Re(x)Fe(100x-z-a-b-c)B(z)Nb(a)Al(b)M(c), wherein x=12-16, z=5.5-6.5, a=0.05-1, b=0-0.8, and c=0-3. Re stands for rare earth elements, which comprises one or more of Nd, Pr, Gd, Ho, Dy and Tb. By adding Nb, Hcj can be improved, the rectangle degree of J-H demagnetization curve can be improved, and the temperature stability of the product can also be improved; and by adding Nb, the amount of Dy and Tb in heavy rare earth can be reduced, and the cost of the material can also be reduced.

### REFERENCE TO PENDING APPLICATIONS

This application is a U.S. National Stage application filed under 35 U.S.C. §371, claiming priority under 35 U.S.C. §365 of International Application No. PCT/CN2010/073002, filed May 20, 2010 in the Chinese Patent Office.

### REFERENCE TO MICROFICHE APPENDIX

This application is not referenced in any microfiche appendix.

### BACKGROUND OF THE INVENTION

The inversion belongs to a component and a manufacturing method of rare earth permanent magnet material, which particularly relates to a component and a manufacturing process of the rare earth permanent magnet material.

After neodymium iron boron was invented in 1983, the industrial production level was greatly improved, and the performance of products was also greatly improved; but presently many companies cannot produce products with high performances, with the continuous increasing of the price of raw material, the profit of low-end product is smaller and smaller, and many companies want to enter high-end market by improving the performances of the products, but the investment of high-performance production lines for neodymium iron boron is large, and the process requirements are quite serious, that how to realize the volume production of high-end products through low investment costs is a problem for the companies. Presently the price of rare earth material and particularly heavy rare earth material is gradually increased, therefore, we have done a lot of work on the aspect of material cost saving, and the invention is on part of the achievement of our company.

### SUMMARY OF THE INVENTION

The invention solves the technical problem of providing a component and a manufacturing process of the rare earth permanent magnet material.

The invention adopts the technical scheme that: a component of rare earth permanent magnet material is characterized in that: Re(x)Fe(100-x-z-a-b-c)B(z)Nb(a)Al(b)M(c);
wherein x=12-16, z=5.5-6.5, a=0.05-1, b=0-0.8 and c=0-3; Re stands for all the rare elements, which comprises at least one or more of Nd, Pr, Gd, Ho, Dy and Tb.

A manufacturing process of the rare earth permanent magnet material is characterized in that: firstly, after various materials are compounded according to the above atomic compounding ratio, then strip casting is performed on the materials in a intermediate frequency induction vacuum rapid hardening furnace; the strip casting process comprises the steps of: turning on a heating power source for heating within 1 Pa vacuum degree, charging about 0.05 MPa argon gas into the furnace for refining before the materials are molten, and pouring molten steel when the temperature of the molten steel is about 1400 DEG C., to ensure that the molten steel flows to a rotating copper roller with cooling water along a diversion trench, to form foils with the thickness being lower than 0.5 mm.

Secondly, performing foil breaking in a hydrogen decrepitating furnace comprises the steps of: charging hydrogen gas into the hydrogen decrepitating furnace to ensure the cast strip become powder after hydrogen pick-up, wherein a large amount of heat is released during the hydrogen pick-up process, and hydrogen pick-up is required to be performed in a cooling device, then opening a vacuum system for extracting gas after hydrogen pick-up, heating the furnace to 500 to 650 DEG C. to separate out hydrogen atom from the materials, cooling down the equipment to room temperature, and then taking out the products.

Thirdly, the hydrogenated power is prepared to power with smaller particle size with a jet mill, and the average particle size of the magnetic powder is controlled within 2.5 to 4.0 microns.

Fourthly, pressing the powder to molded blanks and sintering it in a high vacuum furnace comprises the steps of: firstly, ensuring that the vacuum degree of the furnace reaches 10-2 Pa, then heating up the furnace to 1040 to 1100 DEG C. and keeping the temperature for 3 to 6 hours, then charging Ar gas for cooling, continuously performing ageing treatment for two times, wherein the temperature of the first ageing treatment is 900 to 950 DEG C. and kept for 1.5 to 3 hours, and then Ar gas is charged for cooling, and the temperature of the second ageing treatment is 460 to 550 DEG C. and kept for 2 to 5 hours, and then Ar gas is charged for cooling, and then performance testing is performed after the blanks are discharged.

The oxygen content is strictly controlled during the milling, pressing and sintering processes, and oxidation pretention measures are required to be adopted for controlling the oxygen content to be lower than 2000 PPM, and the measures are as follows: using a sealable tank during the process of jet milling; sealing the equipment and charging protective gas nitrogen gas during the process of pressing; using a sealed glove box and charging protective gas nitrogen gas during the process of loading the blanks into a sintering furnace; and vacuumizing the sintering furnace before the sintering furnace is heated.

The invention has the effects that:

By adding Nb, Hcj can be improved, the rectangle degree of J-H demagnetization curve can be improved, and the temperature stability of the product can also be improved; and by adding Nb, the amount of Dy,Tb and other heavy rare earth elements can be reduced, and the cost of the material can also be reduced.

Upon reading the included description, other advantages and various alternative embodiments will become apparent to those skilled in the art. These embodiments are to be considered within the scope and spirit of the subject invention, which is only limited by the claims which follow and their equivalents.

### DETAILED DESCRIPTION OF THE INVENTION

The following detailed description shows the best currently contemplated modes of carrying out the invention. The description is not to be taken in a limiting sense, but is made for the purpose of illustrating the general principles of the invention and the best mode for practicing the invention, since the scope of the invention is best defined by the appended claims. The invention is capable of other embodiments and of being practiced or carried out in a variety of ways. It is to be understood that the phraseology and terminology employed herein are for the purpose of description and not of limitation.

A component of rare earth permanent magnet material:

The rare earth permanent magnet material adopts rare earth permanent magnet material with element Nb added, and the atomic percents of the material are: Re(x)Fe(100-x-z-a-b-c)B(z)Nb(a)Al(b)M(c), wherein Re stands for rare earth elements, which comprises at least one or more of Nd, Pr, Gd, Ho, Dy and Tb, and Nb is an essential element in the invention,
x=12-16; z=5.5-6.5; a=0.05-1; b=0-0.8; M is one or more of Co, Cu, Ga, Zr and Si and is an unessential element, and c=0-3.

A manufacturing process: various materials (alloy materials are available) are put into a vacuum rapid hardening furnace for sheet casting, then subjected to hydrogenization breaking is a hydrogen breaking furnace, and prepared into magnetic powder with the mean particle size being 2.5 to 4 um in jet mill equipment, then the powder is moulded by a magnetic field orienting press, and then put the product into a vacuum sintering furnace sintering and aging.

The use of an adding element Nb is related in the method, the atomic percents of the material are Re(x)Fe(100-x-z-a-b-c)B (z)Nb(a)Al(b)M(c), wherein Re stands for rare earth elements, which comprises at least one or more of Nd, Pr, Gd, Ho, Dy and Tb, X=12-16; Z=5.5-6.5; Nb is an essential element, a=0.05-1; b=0-0.8; M is one or more of Co, Cu, Ga, Zr and Si, c=0-3.

The main production process comprises the following steps that:

Firstly, various materials (alloy materials are available) are put into a intermediate frequency induction vacuum rapid hardening furnace according to the above atomic percents for strip casting, and the sheet casting process comprises the steps of turning on a heating power source for heating within 1 Pa vacuum degree, charging about 0.05 MPa argon gas for refining before the materials are molten, pouring molten steel when the temperature of the molten steel reaches 1400 DEG C., to ensure that the molten steel flows to a rotating copper roller with cooling water along a diversion trench, to form foils with the thickness being lower than 0.5 mm (when the thickness is larger than 0.5 mm, component segregation can easily occur, and α-Fe which does not facilitate the permanent magnet performance is easy to produce).

Secondly, rare earth alloy has the characteristic that it is easy to react with hydrogen gas, so the rare earth alloy could be broken with hydrogen decrepitating furnace, firstly hydrogen gas is charged into the hydrogen breaking furnace, to ensure that the cast strip form power after hydrogen pick-up (a large amount of heat is discharged during the hydrogen pick-up process, and a cooling device is required to be arranged), the vacuum system of the equipment is opened after hydrogen pick-up, and heating the furance to 500 to 650 DEG C. to ensure that hydrogen atom is separated out from the inner part of material, the equipment is cooled down to room temperature, and then the product is taken out from the equipment.

Thirdly, the hydrogenated powder is prepared with power with smaller grain size, and the average grain size of the magnetic powder is controlled within 2.5 to 4.0 um.

Fourthly, the magnetic powder is moulded by a magnetic field orienting moulding press with the magnetic field being larger than 1.8 KOe, to ensure the density of the blanks is within 4 to 4.3 g/cm³, and internal crack can happen when the density is too high.

Fifthly, sintering the moulded blanks in a high vacuum furnace comprises the steps of: firstly, ensuring that the vacuum degree of the furnace reaches 10-2 Pa, then heating up the furnace to 1040 to 1100 DEG C. and keeping the temperature for 3 to 6 hours, then charging Ar gas for cooling, continuously performing ageing treatment for two times, wherein the temperature of the first ageing treatment is 900 to 950 DEG C. and kept for 1.5 to 3 hours, and then Ar gas is charged for cooling, and the temperature of the second ageing treatment is 460 to 550 DEG C. and kept for 2 to 5 hours, and then Ar gas is charged for cooling, and then performance testing is performed.

The oxygen content is strictly controlled during the milling, pressing and sintering processes, and oxidation pretention measures are required to be adopted for controlling the oxygen content to be lower than 2000 PPM, and the measures are as follows: using a sealable tank during the process of jet milling; sealing the equipment and charging protective gas nitrogen gas during the process of pressing; using a sealed glove box and charging protective gas nitrogen gas during the process of loading the blanks into a sintering furnace; and vacuumizing the sintering furnace before the sintering furnace is heated.

Compared with the product prepared by a compounding formula without Nb added, the product prepared by the above compounding formula and production process has the advantages that:

Firstly, the rectangle degree of J-H demagnetization curve is high, the temperature stability is good, the batch consistency the products is good, and the yield of the products is high;

Secondly, Hcj of the products can be improved by adding heavy rare earth element, such as Dy, Tb and the like, to the neodymium iron boron compounding formula, and by adding Hcj, Hcj can be increased the demands for heavy rare earth element can be reduced, and the cost can be reduced.

### EMBODIMENTS

The following embodiments aim at further explaining the invention, and the invention is not limited to the following embodiments.

### Embodiment 1

According to the following atomic percents
(Pr,Nd)_{13.35}Dy_{0.1}B_{5.85}Nb_{0.15}Al_{0.1}Fe_{residual}
(Pr,Nd)_{13.2}Dy_{0.25}B_{5.85}Nb_{0.1}Al_{0.1}Fe_{residual}

Materials are prepared according to the atomic percents of (Pr,Nd)_{13.35}Dy_{0.1}B_{5.85}Nb_{0.15}Al_{0.1}Fe_{residual} and (Pr,Nd)_{13.2}Dy_{0.25}B_{5.85}Nb_{0.1}Al_{0.1}Fe_{residual}, wherein Pr and Nd are added as an alloy type, the content of Pr is about 20 percent, the average grain size of the power prepared by the jet mill is 3.0 um, orienting moulding is performed in a 1.9 T magnetic field, and the density of the blanks is 4.2 g/cm3; then the powder is sintered in a vacuum sintering furnace, the temperature is 1055 DEG C. and kept for 4 hr; then aging treatment is performed for two times, the temperature for the aging treatment for the first time is 900 DEG C. and kept for 2 hours; and the temperature for the aging treatment for the second time is 470 DEG C. and kept for 3 hours, then performance testing is performed on the powder which is taken out from the furnace.

| | Molecular formula | Br/kGs | Hcj/kOe | Hk/kOe | (BM) max |
|---|---|---|---|---|---|
| 1 | (Pr,Nd)_{13.35}Dy_{0.1}B_{5.85}Nb_{0.15}Al_{0.1}Fe_{residual} | 14.52 | 12.5 | 12.22 | 51.1MGOe |
| 2 | (Pr,Nd)_{13.2}Dy_{0.25}B_{5.85}Nb_{0.1}Al_{0.1} | 14.5 | 12.3 | 11.53 | 50.8MGOe |

The oxygen contents of the two samples are 800 to 1000 PPM, from the contrast, it can be seen that Hcj of the two samples is basically the same, but as the amount of Dy is less in the compounding formula with Nb added, the cost of the compounding formula is low, and the Hk/Hcj of the product with Nb added, the rectangle degree of the demagnetization curve is good.

### Embodiment 2

(Pr,Nd)_{10.65}Dy_{2.85}B₆Nb_{0.3}Al_{0.5}Co₂Cu_{0.2}Fe_{residual}
(Pr,Nd)_{10.4}Dy_{3.1}B₆Al_{0.5}Co₂Cu_{0.2}Fe_{residual}

Materials are prepared according to the atomic percents of (Pr,Nd)_{10.65}Dy_{2.85}B₆Nb_{0.3}Al_{0.5} Co₂Cu_{0.2}Fe_{residual} and (Pr,Nd)_{10.4}Dy_{3.1}B₆Al_{0.5}Co₂Cu_{0.2}Fe_{residual}, wherein Pr and Nd are added as an alloy type, the content of Pr is about 20 percent, the average grain size of the power prepared by the jet mill is 3.0 um, orienting moulding is performed in a 1.9 T magnetic field, and the density of the blanks is 4.2 g/cm3; then the powder is sintered in a vacuum sintering furnace, the temperature is 1075 DEG C. and kept for 4 hr; then aging treatment is performed for two times, the temperature for the aging treatment for the first time is 910 DEG C. and kept for 2 hours; and the temperature for the aging treatment for the second time is 500 DEG C. and kept for 3 hours, then performance testing is performed on the powder which is take.

| | | | | Hk/kOe | |
|---|---|---|---|---|---|
| | Molecular formula | Br/kGs | Hcj/kOe | (at 180° C.) | (BM) max |
| 1 | (Pr,Nd)_{10.65}Dy_{2.85}B₆Nb_{0.3}Al_{0.5}Co₂Cu_{0.2}Fe_{residual} | 12.35 | 29.5 | 9.0 | 37.2MGOe |
| 2 | (Pr,Nd)_{10.4}Dy_{3.1}B₆Al_{0.5}Co₂Cu_{0.2}Fe_{residual} | 12.4 | 29.8 | 8.5 | 37.35MGOe |

The oxygen contents of the two samples are 1000 to 1500 PPM, from the contrast, it can be seen that Hcj of the two samples is almost the same, but as the amount of Dy is much less in the compounding formula with Nb added, and after Hcj of products is tested at 180 DEG C., hcj of the product with Nb added is high, and it means that the added Nb improves the temperature resistant performance of neodymium iron boron.

### Embodiment 3

(Pr,Nd)_{12.6}Dy_{0.7}Tb_{0.1}B₆Nb_{0.2}Al_{0.3}Co_{0.5}Fe_{residual}
(Pr,Nd)_{12.5}Dy_{0.6}Tb_{0.3}B₆Al_{0.3}Co_{0.5}Fe_{residual}

Materials are prepared according to the atomic percents of (Pr,Nd)_{12.6}Dy_{0.7}Tb_{0.1}B₆Nb_{0.2}Al_{0.3}Co_{0.5}Fe_{residua} and (Pr,Nd)_{12.5}Dy_{0.6}Tb_{0.3}B₆Al_{0.3}Co_{0.5}Fe_{residual}, wherein Pr and Nd are added as an alloy type, the content of Pr is about 20 percent, the average grain size of the power prepared by the jet mill is 3.0 um, orienting moulding is performed in a 1.9 T magnetic field, and the density of the blanks is 4.2 g/cm3; then the powder is sintered in a vacuum sintering furnace, the temperature is 1070 DEG C. and kept for 4 hr; then aging treatment is performed for two times, the temperature for the aging treatment for the first time is 900 DEG C. and kept for 2 hours; and the temperature for the aging treatment for the second time is 480 DEG C. and kept for 3 hours, then performance testing is performed on the powder which is taken out from the furnace.

| | Molecular formula | Br/kGs | Hcj/kOe | Hk/kOe | (BM) max |
|---|---|---|---|---|---|
| 1 | (Pr,Nd)_{12.6}Dy_{0.7}Tb_{0.1}B₆Nb_{0.2}Al_{0.3}Co_{0.5}Fe_{residual} | 13.8 | 17.9 | 17.1 | 46.4MGOe |
| 2 | (Pr,Nd)_{12.5}Dy_{0.6}Tb_{0.3}B₆Al_{0.3}Co_{0.5}Fe_{residual} | 13.85 | 18.1 | 17.1 | 46.4MGOe |

The oxygen contents of the two samples are 800 to 1000 PPM, from the contrast, it can be seen that Hcj of the two samples is almost the same, but as the amount of Dy is less in the compounding formula with Nb added, the manufacturing cost is higher. After the samples are processed to 6×1.5×0.5 product to be heated to 100 DEG C., the temperature is kept for 4 hr, and then the comparative attenuation results of the magnetic flux before heating and the magnetic flux after heating are as follows:

| | | Magnetic flux | Magnetic flux | Attenuation |
|---|---|---|---|---|
| Sample | Serial number | before heating | after heating | proportion |
| 1 | 1 | 2.76 | 2.64 | 4.3% |
| | 2 | 2.77 | 2.65 | 4.3% |
| | 3 | 2.76 | 2.63 | 4.7% |
| 2 | 1 | 2.74 | 2.52 | 8.0% |
| | 2 | 2.77 | 2.51 | 9.4% |
| | 3 | 2.75 | 2.52 | 8.4% |

From the comparative results, it can be seen that Hcj of the compounding formula with Nb is higher than that of the compounding formula without Nb, but the results of the heat reducing magnetic test show that the temperature resistant performance of the compounding formula with Nb is good and the magnetic flux attenuation of the compounding formula with Nb is less, and show that NB improves the temperature stability of the products.

While embodiments of the present invention have been illustrated and described, such disclosures should not be regarded as any limitation of the scope of our invention. The true scope of our invention is defined in the appended claims. Therefore, it is intended that the appended claims shall be construed to include both the preferred embodiment and all such variations and modifications as fall within the spirit and scope of the invention.

We claim:

1. A component of rare earth permanent magnet material being characterized having atomic percents of the material are as follows:
Re(x)Fe(100-x-z-a-b-c)B(z)Nb(a)Al(b)M(c), wherein x has a range between 12 and 16, z has a range between 5.5 and 6.5, a has a range between 0.05 and 1, b has a range between 00 and 0.8 and c has a range between 0 and 3; and
wherein Re comprises at least one or more of Nd, Pr, Gd, Ho, Dy and Tb.

2. A manufacturing process of rare earth permanent magnet material, comprising the steps of:
compounding materials from the following: Re(x)Fe(100-x-z-a-b-c)B(z)Nb(a)Al(b)M(c), wherein x has a range between 12 and 16, z has a range between 5.5 and 6.5, a has a range between 0.05 and 1, b has a range between 0 and 0.8 and c has a range between 0 and 3; and wherein Re comprises at least one or more of Nd, Pr, Gd, Ho, Dy and Tb;
strip casting the compounded materials in a intermediate frequency induction vacuum rapid hardening furnace, said strip casting process comprises the steps of: turning on a heating power source for heating within 1 Pa vacuum degree, charging about 0.05 MPa argon gas into the furnace for refining before the materials are molten, and pouring molten steel when the temperature of the molten steel is about 1400 DEG C., to ensure that the molten steel flows to a rotating copper roller with cooling water along a diversion trench, to form foils with the thickness being lower than 0.5 mm;
performing foil breaking in a hydrogen decrepitating furnace comprises the steps of: charging hydrogen gas into the hydrogen decrepitating furnace to ensure the cast strip become powder after hydrogen pick-up, wherein a large amount of heat is released during the hydrogen pick-up process, and hydrogen pick-up is required to be performed in a cooling device, then opening a vacuum system for extracting gas after hydrogen pick-up, heating the furnace to 500 to 650 DEG C. to separate out hydrogen atom from the materials, cooling down the equipment to room temperature, and then taking out the products;
utilizing the hydrogenated power to power with smaller particle size with a jet mill, and the average particle size of the magnetic powder is controlled within 2.5 to 4.0 microns; and
pressing the powder to molded blanks and sintering it in a high vacuum furnace comprises the steps of: firstly, ensuring that the vacuum degree of the furnace reaches 10-2 Pa, then heating up the furnace to 1040 to 1100 DEG C. and keeping the temperature for 3 to 6 hours, then charging Ar gas for cooling, continuously performing ageing treatment for two times, wherein the temperature of the first ageing treatment is 900 to 950 DEG C. and kept for 1.5 to 3 hours, and then Ar gas is charged for cooling, and the temperature of the second ageing treatment is 460 to 550 DEG C. and kept for 2 to 5 hours, and then Ar gas is charged for cooling, and then performance testing is performed after the blanks are discharged,
wherein the oxygen content is strictly controlled during the milling, pressing and sintering processes, and oxidation pretention measures are required to be adopted for controlling the oxygen content to be lower than 2000 PPM, and the measures are as follows: using a sealable tank during the process of jet milling; sealing the equipment and charging protective gas nitrogen gas during the process of pressing; using a sealed glove box and charging protective gas nitrogen gas during the process of loading the blanks into a sintering furnace; and vacuumizing the sintering furnace before the sintering furnace is heated.
